(19) United States
(12) Patent Application Publication
(10) Pub. No.: US 2022/0010807 A1
(43) Pub. Date: Jan. 13, 2022

(54) CENTRIFUGAL FAN AND FAN BLADES HAVING INTEGRAL COOLING PORTION

(71) Applicant: ACM FAN INC., Brooklyn, NY (US)

(72) Inventors: Zhiqiang LI, Brooklyn, NY (US); Guozheng LI, Beijing (CN)

(21) Appl. No.: 17/011,984

(22) Filed: Sep. 3, 2020

Related U.S. Application Data
(60) Provisional application No. 62/895,960, filed on Sep. 4, 2019.

(51) Int. Cl. F04D 29/28; F04D 29/02; F04D 29/58

(52) U.S. Cl. CPC F04D 29/281; F04D 29/5806; F04D 29/023

(57) ABSTRACT

A blade body for a centrifugal fan assemble including a blade body and an extension blade portion integral to the blade body which when installed on a mounting disc protrudes beyond the mounting disc. Also provided a centrifugal fan assembly including a plurality of fan blades installed on a mounting disc, in which each fan blade includes an extension blade portion protruding beyond the mounting disc and proximal to the driving motor. When the centrifugal fan assembly is in operation, the extension blade portion can provide cooling for the driving motor.

### CROSS REFERENCE TO RELATED APPLICATION

This application claims priority to U.S. provisional application No. 62/895,960, filed Sep. 4, 2019, the disclosure of which is incorporated by reference herein it its entirety.

### TECHNICAL FIELD

The invention relates to the technical field of a centrifugal fan, and in particular, to the structure and manufacture of a centrifugal fan.

### BACKGROUND

Centrifugal fan assemblies include a plurality of impeller blades positioned in a scroll-shaped housing or volute. The housing can include an inlet through which air is drawn by the fan blades, and an outlet through which pressurized air is discharged. The plurality of blades pressurize and accelerate an incoming axial airflow, and discharge the air into a scroll portion of the housing in a substantial radial direction. The blades may be attached to a hub fixed on a rotating shaft of an electric motor, or mounted on an outer periphery of a wheel that rotates about such a hub.

Currently in the commercial or industrial centrifugal fans, the motors driving the centrifugal fans often are not provided with cooling. Sustained operation at high temperature can cause the motors to overheat and shorten the motors' service life. When separate cooling apparatus for the motors is provided, the structure of the entire centrifugal fan becomes complicated and the cost of manufacture increases.

### BRIEF DESCRIPTION OF THE DRAWINGS

FIG. 1A is a plan view of an example fan blade including a cooling portion according to some embodiments of the present invention.

FIG. 1B is a plan view of another example fan blade including a cooling portion arranged at a different position shown in FIG. 1.

FIG. 2 is a left view of an example fan blade according to some embodiments of the present invention.

FIG. 3 is a cross-section view of a fan blade shown in FIG. 1 along the line A-A.

FIG. 4 is a schematic depiction of an example fan assembly according to some embodiments of the present invention.

FIG. 5 is a photograph of an example fan assembly, with annotations, according to some embodiments of the present invention.

### DETAILED DESCRIPTION OF EMBODIMENTS

It should be noted that the embodiments in the present application and the features in the embodiments may be combined with each other without conflict. The invention will be described in detail below with reference to the drawings in conjunction with the embodiments.

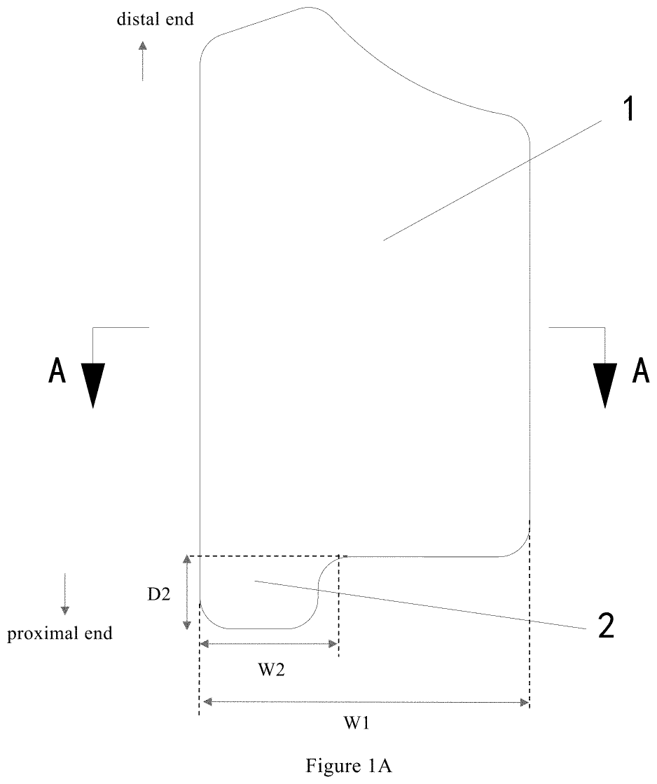

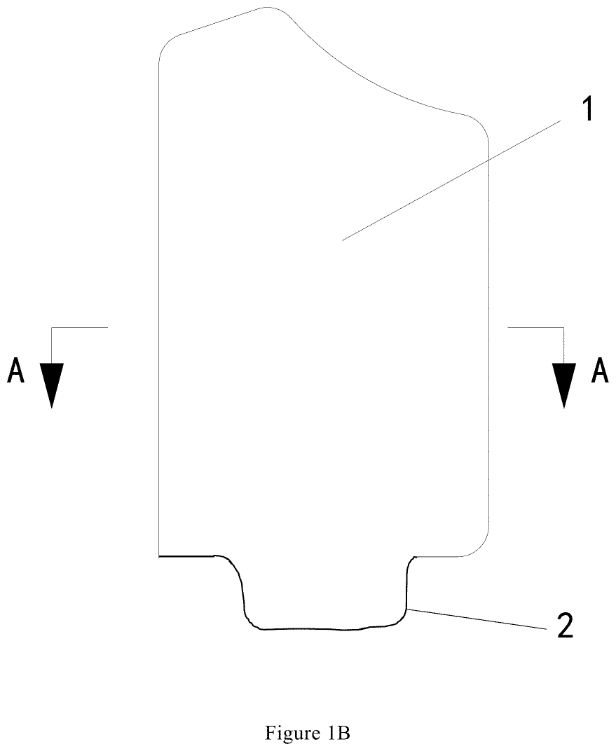

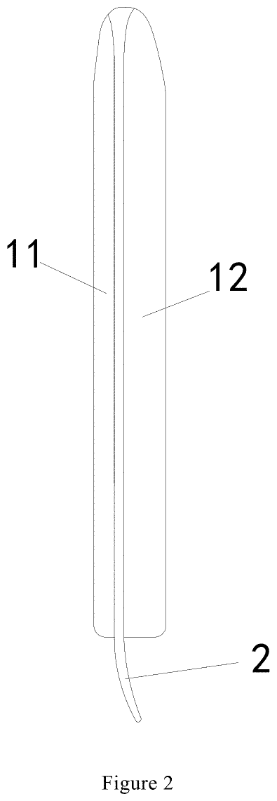

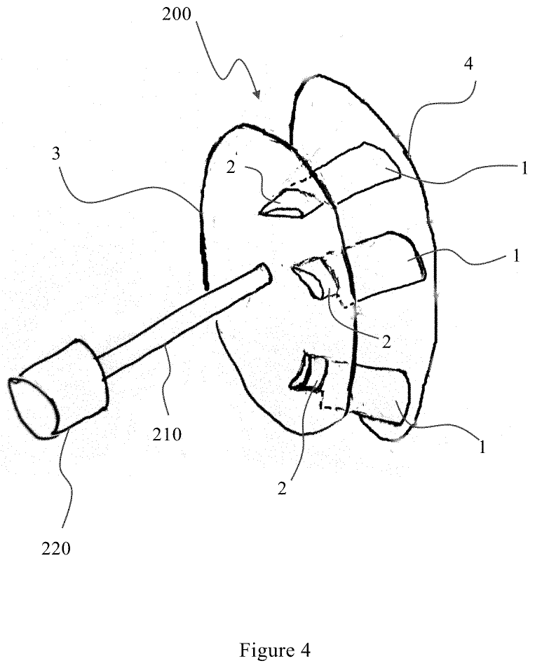

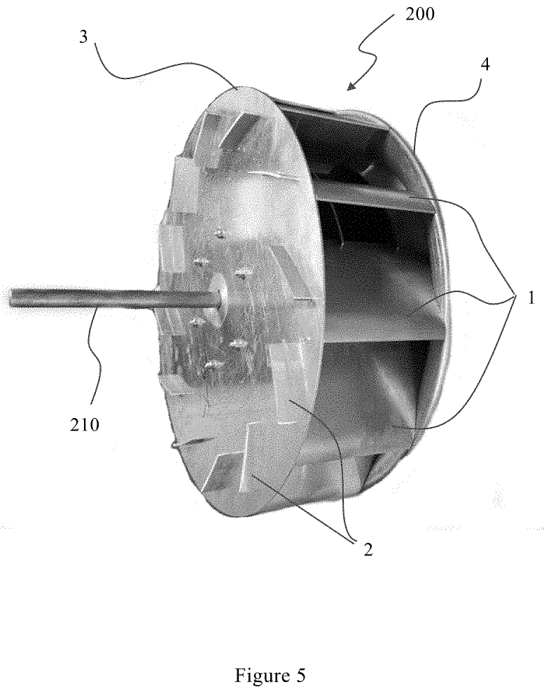

As shown in FIGS. 1A, 1B and 2-5, an example impeller/fan blade of the present invention for a centrifugal fan can include: the fan blade body 1 which includes an extension (or cooling blade) portion 2 on a proximal end for cooling the driving motor 220 (which can be coupled to the fan assembly 200 via a shaft 210 and associated gears/coupling mechanisms). The centrifugal fan assembly 220 includes a plurality of fan blades 1, a rear mounting disc 3 and a front mounting disc 4, between which the blades are mounted. The cooling blade portion 2 can be manufactured as an integral part of the fan blade body 1, for example, the fan blade body 1 (including the cooling portion) can be extrusion formed from an aluminum alloy, and if necessary, the cooling blade portion can be further processed.

In some embodiments as shown, each of the mounting discs may have a circular shape having a radius (same or different). The rear mounting disc 3 is proximal to the driving motor. In other embodiments, the front disc can be omitted, and the blades can be installed on the rear mounting disc with side edges mounted on a cylindrical wall.

The mounting on the mounting disc can be accomplished by inserting the fan blade body 1 into pre-fabricated slits or other openings on rear mounting disc 3 which are dimensioned and configured to accommodate the cross-section profile of the cooling blade portion, and the fan blade body 1 (together with the cooling blade portion 2) can be welded to the rear mounting disc 3. When the fan assembly 200 is assembled, each cooling blade portion 2 protrudes outside of the rear mounting disc 3 toward the motor, such that the air flow generated by the cooling blade portion 2 can cool the motor. The remainder of the blade body 1 is disposed between the rear mounting disc 3 and the front mounting disc 4. The distal end of the fan blade body 1 can be welded or otherwise affixed on the front disc 4. Each of the blades (and the cooling blade portion) can be installed on the mounting discs along the rotation axis of the disc(s) in a radially symmetric fashion.

The position, shape, depth (D2) and width (W2) of the cooling portion 2 can be varied to suit different applications and specific cooling demands. The width W2 can be the same with or smaller than that of the blade body 1 W1. For example, FIG. 1B shows that the cooling portion 2 is arranged at a different lateral position relative to the blade body 1. In other embodiments, the cooling portion does not have an obvious tab or shape that clearly distinguishes it from the remainder of the blade body, and the portion that is left protruding out of the rear mounting disc after installation can be considered the cooling portion 2.

When in operation (the fan assembly 200 being rotated by the driving motor), the plurality of fan blades 1 between the two mounting discs of the centrifugal fan assembly 200 can produce an outgoing air flow that is substantially perpendicular to the rotating axis/shaft. In some embodiments, the cooling blade portion 2 can be shaped and configured to produce primarily an axial air flow toward the motor. In such embodiments, the cooling blade portion 2 can be bent or otherwise deformed from the fan blade body 1.

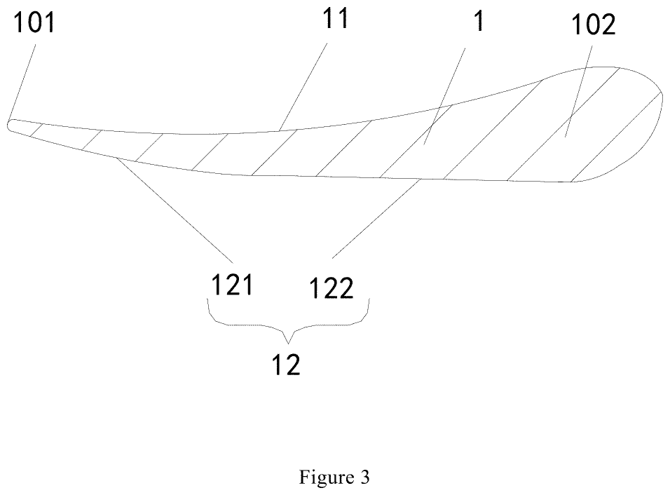

The cross section shape of the cooling blade portion and/or that of the blade body 1 can be any suitable shape. In some embodiments, as shown in FIG. 3, the blade body 1 can have an asymmetrical arcuate curved surface. This design can meet the requirements of higher precision and higher air flow speed, further avoiding eddy currents, ensuring that the blade body 1 does not vibrate, thereby avoiding noise, and further prolonging the service life of the centrifugal fan. In order to reduce eddy currents, the cross section of the blade body 1 can take a shape that is gradually enlarged from a first lateral (or front) end to a second lateral (or rear) end. In the embodiment shown in FIG. 3, the blade body 1 includes a rotating windward surface 11 and a rotating leeward surface 12, wherein the windward surface 11 is a side of the blade body 1 that rotates against the wind. The rotating windward surface 11 can have a uniform arc shape, and the rotating leeward surface 12 can have a plurality of arcs smoothly joined. The plurality of circular arc transitions prevent the wind flow through the rotating leeward surface 12 from flowing toward the rotating windward surface 11, thereby preventing the formation of eddy currents.

In some embodiments, in order to reduce the design difficulty and the high process precision requirements, the rotating leeward surface 12 includes two smooth transitional arc surfaces, namely a front end leeward surface 121 and a rear end leeward surface 122. The radius of the arc surface of the front leeward surface 121 can be similar or about the same as the radius of the rotating windward surface 11 so that the air entering the axial direction of the centrifugal fan can enter adjacent centrifugal blade space more smoothly. In such a manner, a high working efficiency of the centrifugal fan can be attained.

As the front end leeward surface 121 extends toward the rear end leeward surface 122, it also further deviates away from the rotating windward surface 11. The rear end is larger in cross section, ensuring the strength of the blade satisfy the operating needs. Also, since the centrifugal fan structure is usually designed as a circular structure, the rear end of the centrifugal blade is often installed in the circumferential direction of the circular structure (that is, the end that is distal from the central rotating axis). This difference in dimensions between the front end and rear end of the blade also helps reduce the space between adjacent centrifugal blades toward the circumference. Excessive space between adjacent blades can result in the formation of eddy currents, which in turn lead to noise and vibration defects.

In order to avoid excessive increase in the size of the curved blade, and to ensure that the wind flow can flow on a relatively gentle arc surface, the radius of the rear leeward surface 122 is larger than the radius of the front leeward surface 121, and the rear leeward surface 122 is extended away from the end of the front leeward surface 121. Preferably, the blade body 1 further includes a front end portion 101 and a rear end portion 102. In order to make the wind flow more uniform and smooth, the upper and lower sides of the front end portion 101 smoothly transition from the rotating windward surface 11 and the front end leeward surface 121, respectively. The cross section of the rear end surface 102 can have an elliptical shape, and the upper and lower sides of the rear end surface 102 smoothly transition with the rotating windward surface 11 and the rear end leeward surface 122, respectively.

The terms “comprises” and “comprises” and “comprises”, and any variations thereof used herein, are intended to cover non-exclusive inclusions, for example, a process, method, system, product, or device that comprises a series of steps or units is not necessarily limited to those steps that are clearly listed. Or units, but may include other steps or units not explicitly listed or inherent to such processes, methods, products, or devices.

It is to be noted that the terminology used herein is for the purpose of describing particular embodiments, and is not intended to limit the exemplary embodiments. As used herein, the singular forms are also intended to include the plural, unless the context clearly indicates otherwise, and it is also understood that when the terms “include” and/or “include” are used in the specification, There are features, steps, operations, devices, components, and/or combinations thereof.

What is claimed is:

1. A centrifugal fan assembly comprising:
at least a first mounting disc and a second mounting disc, the first mounting disc being disposed more proximal to a driving motor coupled to the fan assembly;
a plurality of fan blades mounted on the first mounting disc, each fan blade including:
an extension portion protruding beyond the first mounting disc and toward the motor;
a remainder portion disposed between the first mounting disc and the second mounting disc,
wherein the extension portion and the remainder portion is manufactured as one integral part.

2. The centrifugal fan assembly of claim 1, wherein the extension portion of each fan blade is configured to produce an axial air flow toward the motor when the fan assembly is in operation.

3. The centrifugal fan assembly of claim 1, wherein each fan blade has a width direction and a uniform and solid cross section perpendicular to the width direction, the cross-section having two major opposing sides, a first lateral end, and a second lateral end, the two opposing sides being both smooth curves generally, the two opposing sides defining a thickness therebetween.

4. The fan blade of claim 3, wherein the two major opposing sides curving to to a same direction, and wherein the thickness gradually increases from the first lateral end to the second lateral end.

5. The centrifugal fan assembly of claim 1, wherein at least one of the fan blades is made of an extruded aluminum alloy.

6. The centrifugal fan assembly of claim 1, wherein at least one of the fan blades include a cooling blade portion having a smaller width than that of the remainder portion.

7. The centrifugal fan assembly of claim 1, wherein at least one of the fan blades is made of an extruded aluminum alloy.
